(19) United States
(12) Patent Application Publication
(10) Pub. No.: US 2014/0272492 A1
(43) Pub. Date: Sep. 18, 2014

(54) SAFETY DEVICE FOR A GALVANIC CELL

(71) Applicant: Robert Bosch GmbH, Stuttgart (DE)

(72) Inventors: Ulrich Lange, Aichtal (DE); Felix Eberle, Ulm (DE)

(73) Assignee: Robert Bosch GmbH, Stuttgart (DE)

(21) Appl. No.: 14/202,233

(22) Filed: Mar. 10, 2014

(30) Foreign Application Priority Data
Mar. 13, 2013 (DE) 10 2013 204 319.8

(51) Int. Cl. H01M 2/34

(52) U.S. Cl. CPC H01M 2/345
USPC 429/61

(57) ABSTRACT

A safety device is configured for use in a galvanic cell. The galvanic cell includes an electrode assembly accommodated in a cell interior of a cell housing. The cell housing has a negative pole and a positive pole. The safety device includes a safety membrane and a strip-shaped safety element which has a deflectable end configured to cover the safety membrane.

This application claims priority under 35 U.S.C. §119 to patent application number DE 10 2013 204 319.8, filed on Mar. 13, 2013 in Germany, the disclosure of which is incorporated herein by reference in its entirety.

### BACKGROUND

Nowadays, lithium-ion battery cells are used in electric vehicles or hybrid vehicles. In general, lithium-ion battery cells are connected to one another electrically via suitable metallic connecting elements to form battery modules, which for their part are combined in battery packs. In respect of the use of lithium-ion battery cells, various tests with the lithium-ion battery cells are performed in order to be permitted for use in passenger transport and in motor vehicles. These tests also include the so-called “abuse test”, in which the response of the battery cells even in extreme situations, such as, for example, in the event of the occurrence of an accident, can be assessed.

Furthermore, such tests on lithium-ion battery cells also include an overcharge test. In order to attenuate the consequences of an overcharge test, for example, an overcharge additive can be added to the electrolyte used in the lithium-ion battery cells. This overcharge additive is, for example, diphenyl or cyclohexylbenzene.

In the context of a standard for the assessment of extreme situations occurring or the reaction of a battery cell or a battery module to this extreme situation, the following EUCAR hazard levels are distinguished:

| Level | Maximum possible hazard |
|---|---|
| Level 0 | No effect |
| Level 1 | Passive safety device trips |
| Level 2 | Defect, damage |
| Level 3 | Leakage, material consumption >50% |
| Level 4 | Venting, material consumption >50% |
| Level 5 | Fire or flame |
| Level 6 | Rupture |
| Level 7 | Explosion |

In order to achieve at least hazard level 4 indicated above in the case of battery modules which are connected electrically to one another and which comprise a number of lithium-ion battery cells, in general mechanical protective measures are used, with which the individual battery cells are protected. For this, fuses can be built into the battery cells, for example, which fuses interrupt a current flow within the battery cell if the pressure prevailing in the interior of the battery cells rises owing to the occurrence of an accident. Such safety devices such as the fuses mentioned above include “current interrupt devices” (CIDs) or else “overcharge safety devices” (OSDs).

### SUMMARY

The disclosure proposes a safety device which can be used in particular for a galvanic cell such as, for example, at least one battery cell, which has at least one electrode assembly which is accommodated in a cell interior of a cell housing, which comprises a negative pole and a positive pole, wherein the safety device contains a strip-shaped safety element, which has a free deflectable end which covers a safety membrane.

A battery cell with overcharge protection which reaches EUCAR hazard level 4, in particular in the case of overcharging, and is possibly also capable of reaching better EUCAR hazard levels, can be provided by the proposed safety device for at least one galvanic cell. The safety device proposed according to the disclosure can be used to avoid the addition of an overcharge additive to the electrolyte. In turn, the electrochemical properties of the electrolyte can thus be considerably improved in general.

In an advantageous development of the safety device proposed according to the disclosure, a strip-shaped safety element is accommodated on the cell housing of the galvanic cell in such a way that the articulation point of the strip-shaped safety element at which said safety element is electrically conductively connected to the cell housing is located at a distance a from a deformable safety membrane. As a result, the free end of the strip-shaped safety element can be deflected against a contact link arranged above the strip-shaped safety element in the event of a deformation, for example in the event of the safety membrane curving outwards. In this case, an electrically conductive connection is provided between the contact link and the cell housing.

In a further advantageous configuration of the concept on which the disclosure is based, the strip-shaped safety element and the fastening thereof on the cell housing have a lower internal resistance than the internal resistance that the material from which the safety membrane is manufactured has.

The safety device proposed according to the disclosure furthermore comprises a contact link, which is arranged at one of the poles of the galvanic cell and is located above the deflectable free end of the strip-shaped safety element mounted on one side. The strip-shaped safety element itself can be provided with an insulator or a material having insulating properties on its side which faces the safety membrane. By virtue of the safety device proposed according to the disclosure, the electrical resistance of a path which extends, for example, from the negative pole of the galvanic cell, via the contact link and the strip-shaped safety element to the cell housing is set in such a way that both the electrode assembly accommodated in the interior of the cell housing is protected from an overcharge current and a short-circuit current which flows via the safety membrane in the event of the occurrence of a short circuit is limited. In particular, the electrical resistance of the path with the abovementioned components is lower than the internal resistance of a fully charged cell (100% SOC).

In the case of the safety device proposed according to the disclosure, tripping takes place at a state of charge (SOC) which is 150% SOC in the case of a 60 Ah galvanic cell, and wherein the internal resistance is approximately 150 mΩ, with a cell voltage of 5 volts and an overcharge current of 32 amperes. A “30 second charging resistance” at +25° C., 90% SOC and 45 amperes charging current is of the order of magnitude of approximately 1 mΩ. In order to limit the short-circuit current of the battery cell in an expedient manner, values of the charging resistance of between 10 mΩ and 100 mΩ are sufficient.

The safety device proposed according to the disclosure can further comprise a mechanical blocking means, which prevents undesired contact of the strip-shaped safety element with the contact link at one of the poles of the cell housing by vibrations. By virtue of the mechanical blocking means, undesired oscillation of the free deflectable end of the strip-shaped safety element can be prevented.

In order to increase the lever effect of the free deflectable end of the strip-shaped safety element and therefore to keep the influence of the function of the safety membrane as low as is actually only possible, the strip-shaped safety element can have a variety of embodiments. In this case, in particular different lever lengths of the free deflectable end in relation to the electrically conductive connecting region to the cell housing thereof can be implemented.

In a development of the concept proposed by the disclosure, the safety device proposed according to the disclosure can be used both on the anode side of a lithium-ion battery cell, and also, with the same configuration, on the cathode side. With this possible embodiment, the cell housing of the battery cell can be left potential-free.

In a further possible embodiment of the concept on which the disclosure is based, there is the possibility of coating the strip-shaped safety element or the contact side of the contact link at one of the poles of the cell housing such that the resistance is within the above-described range, wherein a highly resistive material can be used. The resistance should be higher than the internal resistance of the battery cells for which protection is required.

By virtue of the safety device proposed according to the disclosure, whether it be associated with the negative pole, the positive pole or both poles of a battery cell, a battery cell can be provided which has overcharge protection. At worst, this reaches EUCAR hazard level 4 in the case of overcharging. A further advantage of the solution proposed according to the disclosure can be considered to be the fact that there is no addition of overcharge additive to the electrolyte contained in the electrode assembly, with the result that the electrochemical properties of the electrolyte used in the electrode assembly which are set are considerably improved.

By virtue of limiting the short-circuit current I_{sc}, there is no need for a cell-internal fuse to interrupt this current. This enables controlled discharge of an overcharged cell in an uncritical state. Owing to the lack of the cell-internal fuse, the electrode assembly is not isolated from the terminal in the event of tripping, which makes it possible to check the state of the battery cell. In the event that contact is removed, the overcharged electrode assembly would remain in a critical state in which checking is not possible within the cell housing of the battery cell. The use of the safety device proposed according to the disclosure both on the positive pole side and on the negative pole side enables the use of a potential-free and/or nonconductive housing, which in turn minimizes the risk of the occurrence of an external short circuit.

### BRIEF DESCRIPTION OF THE DRAWINGS

The disclosure will be described in more detail below with reference to the drawings, in which:

FIG. 1 shows a battery cell comprising a safety membrane and a cell-internal fuse,

FIG. 2 shows a safety device on a battery cell in the tripped state and the profile of the overcharge current and the short-circuit current,

FIG. 3 shows a variant embodiment of the safety device proposed according to the disclosure comprising a strip-shaped safety element,

FIG. 4 shows the safety device proposed according to the disclosure in accordance with the illustration in FIG. 3 in the tripped state with profiles of overcharge current and short-circuit current,

FIG. 5 shows a possible embodiment of the strip-shaped safety element, and

FIG. 6 shows a further possible embodiment of the strip-shaped safety element with an extended lever arm.

### DETAILED DESCRIPTION

The illustration shown in FIG. 1 shows a battery cell comprising a safety membrane and a cell-internal fuse.

The illustration shown in FIG. 1 shows a galvanic cell 10, which comprises a cell housing 12 which surrounds a cell interior 14. An electrode assembly 16 (jelly roll) is accommodated in the cell interior 14. In this variant embodiment, the electrode assembly 16 is connected to a positive pole 26 of the galvanic cell 10 by means of a cell-internal fuse 18. The cell housing 12 comprises an opening 28, within which a safety membrane 30 is located, which safety membrane is illustrated in the non-deflected, i.e. non-deformed state in the illustration shown in FIG. 1. Furthermore, the cell housing 12 comprises a negative pole 24, at which a contact link 22 extends laterally, the extent of said contact link reaching as far as beyond the deflectable, i.e. deformable safety membrane 30 of the cell housing 12.

FIG. 2 shows the safety device illustrated in connection with FIG. 1 in the tripped state. In the illustration shown in FIG. 2, the safety membrane 30 is in the tripped state 36. The outward curving of the safety membrane 30 illustrated in FIG. 2 results from a pressure increase in the cell interior 14 of the cell housing 12. In the tripped state 36, the safety membrane 30 makes contact with the lower side of the contact link 22, which in this exemplary embodiment is arranged at the negative pole 24 of the galvanic cell 10. In the case of tripping of the safety membrane 30, i.e. in the event of the contact link 22 coming into contact with the negative pole 24 by means of the safety membrane 30, a short-circuit current 40 flows through the material of the cell housing 12; in addition, the cell-internal fuse 18 has assumed its tripped state 42. In addition to the short-circuit current 40 flowing through the cell housing 12, an overcharge current 38, also illustrated at the positive pole 26 and at the negative pole 24, also flows both through the cell housing 12 and through the material of the tripped safety membrane 36 and the contact link 22. By virtue of the connection between the safety membrane 30 in the tripped state 36 and the contact link 22, there is a lower resistance in comparison with that which the chemically active part of the electrode assembly 16 has. As a result, the overcharge current 38 no longer flows through the electrode assembly 16, but through the cell housing 12. At the same time, as illustrated in FIG. 2, a short circuit results across the cell and the short-circuit current 40 flowing out of the electrode assembly 16 through the cell housing 12 via the safety membrane 32 can destroy the safety membrane 30. This is prevented by virtue of the fact that the cell-internal fuse 18 which interrupts this short-circuit current 40 before it causes destruction of the safety membrane 30 is located in the connection between the electrode assembly 16 and the positive pole 26 or the cell housing 12.

FIG. 3 shows a first possible embodiment of the safety device proposed according to the disclosure.

The illustration shown in FIG. 3 shows that the galvanic cell 10 comprises the cell housing 12, and at least one electrode assembly 16 is located in the cell interior 14 of said cell housing. This electrode assembly is electrically conductively connected to the negative pole 24 via a first current collector 20 and to the positive pole 26 of the galvanic cell 10 via a second current collector 68.

The cell housing 12 has the opening 28, in which the safety membrane 30 which is in the untripped state in FIG. 3 is located. This is part of a safety device 50 proposed according to the disclosure. The safety device 50 shown in the illustration in FIG. 3 comprises a strip-shaped safety element 52, for example in the form of a strip of sheet metal. The strip-shaped safety element 52 is electrically conductively connected to the cell housing 12 of the galvanic cell 10 for which protection is to be provided within a fastening region 58. An upper side of the strip-shaped safety element 52 is identified by reference symbol 54, while a lower side of the strip-shaped safety element 52 is identified by reference symbol 56. Reference symbol 60 denotes a free length along which a freely deflectable region of the strip-shaped safety element 52 extends, starting from the fastening region 58. As can be seen from the illustration shown in FIG. 3, the strip-shaped safety element 52 extends with its deflectable length 60 beyond the safety membrane 30, which is arranged in the opening 28 of the cell housing 12. Optionally, an insulator 62 or a coating having electrically insulating properties can be provided on the lower side 56 of the strip-shaped safety element 52. Furthermore, there is the possibility of attaching a vibration blocking means 64 on the outer side of the cell housing 12. This prevents undesired contact being made between the free end of the strip-shaped safety element 52 and a contact side 66 of the contact link 22, for example in the case of severe vibrations occurring during operation of the vehicle. The illustration shown in FIG. 3 shows that the contact link 22 which extends over the safety membrane 30 is formed at the negative pole 24 of the galvanic cell 10. A contact side of the contact link 22 is denoted by the reference symbol 66 in the illustration shown in FIG. 3. FIG. 3 furthermore shows that, in this variant embodiment, i.e. a possible embodiment of the solution proposed according to the disclosure, a cell-internal fuse 18 (illustrated in FIGS. 1 and 2) is not provided beneath the positive pole 26. A second current collector 68 is introduced instead of the cell-internal fuse 18 in the variant embodiment proposed according to the disclosure in FIG. 3.

The fastening region 58 along which the strip-shaped safety element 52 is connected to the outer side of the cell housing 12 can be in the form of a cohesive connection for example, in particular a welded joint. As a result of the distance, i.e. the deflectable length 60 of the fastening region 58, from the safety membrane 30 and the lever effect which is thus achievable, only an insignificant amount of extra force is required for producing the contact between the cell housing 12 and the contact link 22 at the negative pole 24 than would be required if the strip-shaped safety element 52 were not present. This means that the tripping characteristic of the safety membrane 30 is only insubstantially influenced. If the strip-shaped safety element 50 together with the fastening region 58 has a lower internal resistance in comparison with the material of the safety membrane 30, the majority of a short-circuit current I_{SC}, as shown at position 70, flows through the strip-shaped safety element 52. This means that the safety membrane 30 has a lower probability of being destroyed. Optionally, there is the possibility, as illustrated in FIG. 3, of attaching an insulator 62 or a coating with insulating properties, between the safety membrane 30 and the strip-shaped safety element 52. In this case, there will no longer be a current flow via the safety membrane 32.

The illustration shown in FIG. 4 shows a tripping event together with resultant current profiles.

FIG. 4 shows that, in the event of tripping, i.e. in the event of a pressure rise in the interior 14 of the cell housing 12, the safety membrane 30 assumes its tripped state 36. As shown in the illustration in FIG. 4, the safety membrane 30 in the tripped state 36 makes contact with the lower side of the insulator 62 and deflects the strip-shaped safety element 52 upwards, with the result that said strip-shaped safety element, with its free end, touches the contact side 66 of the contact link 22, which is formed at the negative pole 24. In this case, current profiles 70 and 72 result: according to reference symbol 70, the short-circuit current I_{SC} flows via the second current collector 68 into the top of the cell housing 12, from where it flows via the fastening region 58 into the strip-shaped safety element 52, the contact side 66 of the contact link 22 into the negative pole 24. As shown by reference symbol 72, the overcharge current I_{OC} flows through the positive pole 26, the top of the cell housing 12, likewise through the fastening region 58 and the strip-shaped safety element 52 of the safety device 50, from there via the contact side 66 of the contact link 22 into the negative pole 24.

By virtue of these profiles 70 and 72, there is the possibility of setting the resistance of a path comprising the negative pole 24, the contact link 22, the strip-shaped safety element 52 and the cell housing 12, in a targeted manner such that both protection of the electrode assembly 16 from overcharge current 38 is ensured and a short-circuit current 40 is limited in the event of folding over, i.e. curving outwards of the safety membrane 30, in order thus to limit further heating of an already overcharged electrode assembly 16. In this case, the resistance should be less than the internal resistance of a fully charged cell (100% SOC) during charging in order to dissipate the charging current from the electrode assembly 16 which has already been overcharged, but should be selected to be high enough to limit sufficiently the short-circuit current 40 of a battery cell.

Typically, the tripping state in the event of tripping of the safety device 50 proposed according to the disclosure is approximately 150% SOC in the case of 60 Ah battery cells, and an internal resistance is approximately 150 mΩ, with a cell voltage of 5 volts, and an overcharge current of 32 amperes.

The “30 second charging resistance at 25° C.”, state of charge 90% and 45 amperes charging current is 1 mΩ. In order to limit the short-circuit current 50 of the galvanic cell 10 in an expedient manner, charging resistances of between 10 mΩ and 100 mΩ are sufficient. The illustration shown in FIG. 4 furthermore shows the vibration blocking means 64, which prevents undesired contact of the strip-shaped safety element 52 with the contact side 66 of the contact link 22. The vibration blocking means 64 is configured in such a way that, firstly, effective inhibition of the strip-shaped safety element 52 in respect of vibrations is provided and, secondly, the vibration blocking means 64 can be overcome in the event of the safety membrane 30 curving outwards, i.e. in the event of the tripped state 36 of the safety membrane 30. The illustrations shown in FIGS. 5 and 6 show variant embodiments of the strip-shaped safety element.

FIG. 5 shows that the strip-shaped safety element 52 covers the safety membrane 30 on an upper side 74 of the cell housing 12. In the plan view shown in FIG. 5, the free end is below the contact link 22, whose laterally sweeping limb covers the safety membrane 30 and in this case is formed at the negative pole 24, similar to the illustration in FIG. 6. The strip-shaped safety element 52 is cohesively connected to the upper side 74 of the cell housing 12, for example in the form of a welded joint, within the fastening region 58. Reference symbol 76 denotes a first lever arm, along whose length the free end of the strip-shaped safety element 52 can be deflected. Although arranged at the negative pole 24 in the illustrations shown in FIGS. 5 and 6, the contact link 22 of the safety device 50 can also be embodied at the positive pole 26 of the cell housing 12 of the galvanic cell 10.

FIG. 6 shows the arrangement of the strip-shaped safety element 52 with a second lever arm 78. The second lever arm 78 is extended in comparison with the first lever arm 76 according to the illustration shown in FIG. 5. As a result, there is a reduced influence on the tripping characteristic of the safety membrane 30. Furthermore, the illustration shown in FIG. 6 shows the vibration blocking means 64, which covers a retaining tongue 80 at the free end of the strip-shaped safety element 52.

In a modification of the solution proposed according to the disclosure which is not illustrated in the drawings, there is the possibility of providing the safety device proposed according to the disclosure both at the negative pole 24 of the cell housing 12 of the galvanic cell 10 and at the positive pole 26 of the housing 12 of the galvanic cell 10. This results in the possibility of configuring the cell housing 12 of the galvanic cell 10 to be potential-free. In a further modification of the solution proposed according to the disclosure which is not illustrated in the drawings, the strip-shaped safety element 52 can be provided with a coating consisting of a highly resistive material on the upper side 54 and on the lower side 56 or the contact side 66 of the contacts 22. This resistance should be higher than the internal resistance of the galvanic cell 10 for which protection is to be provided.

What is claimed is:

1. A safety device for a galvanic cell including an electrode assembly accommodated in a cell interior of a cell housing and having a negative pole and a positive pole, the safety device comprising:
a safety membrane; and
a strip-shaped safety element having a deflectable end configured to cover the safety membrane.

2. The safety device according to claim 1, wherein the safety element is electrically conductively connected to the cell housing at a distance a from the safety membrane.

3. The safety device according to claim 1, wherein the safety element and a fastening thereof on the cell housing have an internal resistance that is lower than an internal resistance of the safety membrane.

4. The safety device according to claim 1, further comprising:
a contact link on one of the negative pole and the positive pole of the galvanic cell, the contact link located above the deflectable end of the strip-shaped safety element mounted on one side.

5. The safety device according to claim 1, wherein the strip-shaped safety element has an insulator in a side facing towards the safety membrane.

6. The safety device according to claim 1, wherein an electrical resistance of a path from the negative pole, via the contact link and the strip-shaped safety element, to the cell housing is set such that the electrode assembly is protected from an overcharge current and such that a short-circuit current is limited via the safety membrane.

7. The safety device according to claim 6, wherein the electrical resistance of the path is lower than an internal resistance of a fully charged galvanic cell.

8. The safety device according to claim 1, wherein the safety device trips at a state of charge which is 175% of a state of charge of a 60 ampere-hour galvanic cell with an internal resistance of approximately 200 milliohms.

9. The safety device according to claim 6, wherein the short-circuit current of the galvanic cell is limited by an electrical resistance of between 10 milliohms and 100 milliohms.

10. The safety device according to claim 1, wherein the strip-shaped safety element is fixed by a vibration blocking element to avoid undesired contact with the contact link.

11. The safety device according to claim 1, wherein a deflectable length of the deflectable end of the strip-shaped safety element is formed as a short first lever arm or as an extended second lever arm.

12. The safety device according to claim 1, wherein a safety device is associated with each of the negative pole and the positive pole of the galvanic cell.

13. The safety device according to claim 1, wherein the cell housing is potential-free.

14. The safety device according to claim 1, wherein at least one of the contact link and the strip-shaped safety element includes on at least one side a coating consisting of a highly resistive material.

15. The safety device according to claim 10, wherein the deflectable end of the strip-shaped safety element is fixed by the vibration blocking element.
